(19) United States
(12) Patent Application Publication
(10) Pub. No.: US 2008/0137046 A1
(43) Pub. Date: Jun. 12, 2008

(54) Apparatus and method for exposing substrate

(75) Inventors: Ju-A Ryu, Seoul (KR); Chang-Su Lim, Hwaseong-si (KR); Yo-Han Ahn, Yongin-si (KR); Hyung-Seok Choi, Yongin-si (KR); Kyung-Log Moon, Yongin-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/999,526

(22) Filed: Dec. 6, 2007

(30) Foreign Application Priority Data
Dec. 12, 2006 (KR) 10-2006-0126452

(51) Int. Cl. G03B 27/42; G03B 27/52

(52) U.S. Cl. 355/30; 355/53

(57) ABSTRACT

A substrate exposing apparatus includes an immersion exposure unit, disposed between a projection optical system and a substrate, including a vessel disposed on an optical path and filled with a liquid, a supply line connected to one side of the vessel to supply the liquid to the vessel, a first drain line connected to the other side of the vessel to drain the liquid from the vessel, and a monitoring unit including at least one first measuring unit connected to the first drain line to detect a property of the liquid flowing through the first drain line. The monitoring unit can include a collection line connected to the first drain line to collect the liquid, a first bath storing the collected liquid, and a first distribution line through which the liquid in the first bath can flow. The first measuring unit is installed on the first distribution line.

### CROSS-REFERENCE TO RELATED APPLICATIONS

This U.S. non-provisional patent application claims priority under 35 U.S.C. §119 of Korean Patent Application No. 10-2006-0126452, filed on Dec. 12, 2006, the entire contents of which are hereby incorporated by reference.

### FIELD OF THE INVENTION

The present invention disclosed herein relates to an apparatus and method for exposing a substrate, and more particularly, to an apparatus and method for exposing a substrate using a liquid supplied between a projection optical system and the substrate.

### BACKGROUND

Most integrated circuits are fabricated by optical lithography.

A thin photoresist layer is formed on a wafer by applying light sensitive photoresist to the wafer, and light is irradiated to the photoresist layer through a reticle to selectively expose the photoresist layer. The reticle contains information about a particular layer to be formed on the wafer. Thereafter, the photoresist layer is developed. In this way, a pattern of the reticle can be transferred to the photoresist layer. The photoresist layer can be used as an etch mask or an ion implantation mask.

In the current optical lithography approaches, a projection exposure apparatus is widely used. In the projection exposure apparatus, light is emitted from a high-intensity light source to a reticle through a first lens system (as an illumination optical system). The reticle transmits the light toward a second lens system (as a projection optical system). The second lens system focuses the light onto a wafer. Examples of the projection exposure apparatus include U.S. Pat. No. 6,538,719 issued to Takahashi et al. and owned by Nikon Company, and Korean Patent No. 10-0571371 owned by ASML Company.

It is very important that such an exposure apparatus can print a pattern of a reticle on a wafer very finely and precisely. For this reason, recent exposure apparatuses use an immersion lithography method. According to the immersion lithography method, a liquid having a relatively high reflection index such as pure water is filled between a second lens system and a wafer to obtain improved resolution and depth of focus (DOF).

However, such exposure apparatuses have the following disadvantages.

When a liquid filled between a second lens system and a wafer is contaminated or changes in property, a defective or deformed pattern can be formed on the wafer since the immersion exposure is very sensitive to properties of the liquid. In this case, the process yield decreases. Therefore, it is important to monitor the liquid for determining whether the liquid changes in status or property and how much the liquid changes in status or property. However, the exposure apparatuses have no means for monitoring the status and property of the liquid. Furthermore, the exposure apparatuses have no mechanism for coping with variations of the status and property of the liquid.

If status and property variations of the liquid are ignored, a large number of defective wafers can be fabricated at one time since the exposure process is repeatedly performed using the changed liquid.

### SUMMARY OF THE INVENTION

The present invention provides an apparatus and method for exposing a substrate by an immersion exposure using a measured property of a liquid supplied between the substrate and a projection optical system.

The present invention also provides an apparatus and method for exposing a substrate by an immersion exposure using variously measured properties of a liquid supplied between the substrate and a projection optical system.

The present invention also provides an apparatus and method for exposing a substrate by an immersion exposure without pattern errors caused by variations of the property of a liquid supplied between the substrate and a projection optical system.

The present invention also provides an apparatus and method for exposing a substrate at improved resolution and depth of focus (DOF) levels by an immersion exposure using a detected property of a liquid supplied between the substrate and a projection optical system.

In accordance with one aspect of the present invention, provided is an apparatus for exposing a substrate, the apparatus including: a light source configured to emit light; an illumination optical system configured to illuminate a reticle loaded on a reticle stage with the light emitted from the light source; a projection optical system configured to irradiate the light transmitted through the reticle onto a substrate loaded on a substrate stage; and an immersion exposure unit configured to supply a liquid to an optical path between the projection optical system and the substrate, wherein the immersion exposure unit includes: a vessel disposed on the optical path and filled with the liquid; a supply line connected to one side of the vessel and configured to supply the liquid to the vessel; a first drain line connected to the other side of the vessel and configured to drain the liquid from the vessel; and a monitoring unit including at least one first measuring unit connected to the first drain line and configured to detect a property of the liquid flowing through the first drain line.

The monitoring unit can further include: a collection line connected to the first drain line and configured to collect the liquid; a first bath configured to store the liquid collected through the collection line; and a first distribution line connected to the first bath to allow the liquid in the first bath to flow therethrough, wherein the first measuring unit is installed on the first distribution line.

The monitoring unit can further include a second drain line connected to the first bath and configured to drain the liquid from the first bath.

The monitoring unit can further include a first subsidiary drain line connecting the first measuring unit and the second drain line.

The first measuring unit can be one of a high performance ion chromatography (HPIC) unit and an inductively coupled plasma-mass spectrometer (ICPMS).

The monitoring unit can further include a subsidiary supply line configured to supply the first bath with the same liquid as that supplied to the vessel.

The monitoring unit can further include a fluid meter installed on the subsidiary supply line.

The monitoring unit can further include a mixer including a first inlet connected to an end of the collection line to receive the collected liquid, and a second inlet connected to an end of the subsidiary supply line to receive the same liquid as that supplied to the vessel.

The mixer can further include a plurality of outlets configured to discharge the liquids introduced through the first and second inlets.

The monitoring unit can further include a backflow preventer formed on the collection line configured to prevent the liquids introduced into the mixer through the first and second inlets from reversely flowing along the collection line.

The first bath can include one or more barrier walls configured to divide an inside area of the first bath into a plurality of interconnected compartments.

The barrier walls can include: a first vertical barrier wall extending downward from a ceiling surface of the first bath; and a second vertical barrier wall extending upward from a bottom surface of the first bath.

The first measuring unit can be one of a total organic carbon (TOC) analyzer, a dissolve oxygen (DO) meter, a resistivity meter, and a particle counter.

The monitoring unit can further include: a communication line connected to the first bath to allow the liquid in the first bath to flow therethrough; a second bath connected to the communication line to receive the liquid through the communication line; at least one second distribution line connected to the second bath and configured to allow the liquid in the second bath to flow therethrough ; and at least one second measuring unit installed on the second distribution line and configured to measure a property of the liquid flowing through the second distribution line.

The monitoring unit can further include a subsidiary supply line configured to supply the second bath with the same liquid as that supplied to the vessel.

The monitoring unit can further include: a second drain line connected to the first bath and configured to drain the liquid from the first bath; and a third drain line connected to the second bath and the second drain line and configured to discharge the liquid from the second bath to the second drain line.

The monitoring unit can further comprise a backflow preventer provided on the collection line and configured to prevent the liquids introduced into the mixer through the first and second inlets from reversely flowing along the collection line.

The second bath can comprise one or more barrier walls dividing an inside area of the second bath into a plurality of interconnected compartments.

The monitoring unit can further comprise: a second drain line connected to the first bath and configured to drain the liquid from the first bath; and a third drain line connected to the second bath and the second drain line configured to discharge the liquid from the second bath to the second drain line.

The monitoring unit can further include: a first subsidiary drain line configured to connect the first measuring unit and the second drain line; and a second subsidiary drain line configured to connect the second measuring unit and the second drain line.

In accordance with another aspect of the present invention, provided is an apparatus for exposing a substrate, the apparatuses including: a light source configured to emit light; an illumination optical system configured to illuminate a reticle loaded on a reticle stage with the light emitted from the light source; a projection optical system configured to irradiate the light transmitted through the reticle onto a substrate loaded on a substrate stage; a liquid lens filled with a liquid and disposed on an optical path between the projection optical system and the substrate; and a monitoring unit configured to sample the liquid from liquid lens to measure a property of the liquid.

The monitoring unit can include: a first bath configured to store the sampled liquid; at least one first distribution line connected to the first bath to allow the liquid in the first bath to flow therethrough; and at least one first measuring unit installed on the first distribution line configured to measure a property of the liquid flowing through the first distribution line.

The first measuring unit can be one of a high performance ion chromatography (HPIC) unit and an inductively coupled plasma-mass spectrometer (ICPMS).

The monitoring unit can further include a subsidiary supply line configured to supply the first bath with the same liquid as that supplied to the liquid lens.

The monitoring unit can further include: a communication line connected to the first bath and configured to allow the liquid in the first bath to flow therethrough; a second bath connected to the communication line and configured to receive the liquid through the communication line; at least one second distribution line connected to the second bath and configured to allow the liquid in the second bath to flow therethrough; and at least one second measuring unit installed on the second distribution line and configured to measure a property of the liquid flowing through the second distribution line.

The monitoring unit can further include a subsidiary supply line configured to supply the second bath with the same liquid as that supplied to the liquid lens.

In accordance with another aspect of the present invention, there is provided a method of exposing a substrate to light transmitted through a liquid, the liquid being supplied to an optical path between the substrate and an projection optical system irradiating light transmitted through a reticle to the substrate. The method includes sampling the liquid supplied to the optical path and measuring a property of the sampled liquid using a first measuring unit.

The method can further include: storing an initial property of the liquid measured before supplying the liquid to the optical path; comparing the stored initial property of the liquid with the property of the liquid measured using the first measuring unit; and if the property of the liquid measured using the first measuring unit is different from the initial property of the liquid by more than a predetermined amount, stopping an exposure process.

The method can further include: diluting the sampled liquid by mixing some of the sampled liquid with the liquid that is not supplied to the optical path; and measuring a property of the diluted liquid using a second measuring unit.

The method can further include: storing initial properties of the liquid measured before the liquid is supplied to the optical path; comparing the stored initial properties of the liquid with the properties of the liquid measured using the first and second measuring units, respectively; and if one of the properties of the liquid measured using the first and second measuring units is different from the initial property of the liquid by more than a predetermined amount, stopping an exposure process.

### BRIEF DESCRIPTION OF THE FIGURES

The accompanying figures are included to provide a further understanding of aspects of the present invention, and are incorporated in and constitute a part of this specification. The drawings illustrate exemplary embodiments in accordance with the present invention and, together with the description, serve to explain principles thereof. In the figures:

FIG. 1 is a schematic view illustrating an embodiment of an exposure apparatus according to the present invention;

FIG. 2 is a schematic view illustrating a first embodiment of a monitoring unit according to an aspect of the present invention;

FIG. 3 is a schematic view illustrating a second embodiment of a monitoring unit according to an aspect of the present invention;

FIG. 4 is a view illustrating an embodiment of a collection line and a subsidiary supply line that are connected to a mixer according to an aspect of the present invention;

FIG. 5 is a view illustrating fluid streams in the mixer of FIG. 4;

FIG. 6 is a schematic view illustrating an embodiment of the inside of a first bath according to an aspect of the present invention;

FIG. 7 is a view illustrating an embodiment of the mixer of FIG. 5 installed in the first bath of FIG. 6;

FIG. 8 is a schematic view illustrating a third embodiment of a monitoring unit according to an aspect of the present invention; and

FIG. 9 is a block diagram for explaining an embodiment of a method of exposing a substrate according to an aspect of the present invention.

### DETAILED DESCRIPTION OF PREFERRED EMBODIMENTS

Preferred embodiments in accordance with the present invention will be described below in more detail with reference to the accompanying drawings. The present invention can, however, be embodied in different forms and should not be constructed as limited to the embodiments set forth herein. In the figures, the dimensions of layers and regions are exaggerated for clarity of illustration.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Manufactures produce exposure apparatuses having similar components and functions. However, the arrangement and operational principles of components can be varied according to manufactures. Therefore, in the following description, the functions of components of an exposure apparatus will be mainly explained. The arrangement of the components can be changed different from that described below.

The features of an exposure apparatus of the present invention are similar to those of exposure apparatuses disclosed in U.S. Pat. No. 6,331,885 issued to Nishi and owned by Nikon company, U.S. Pat. No. 6,538,719 issued to Takahashi et al. and owing by Nikon company, and Korean Patent No. 10-0571371 owned by ASML company, except for the characteristic features of the exposure apparatus. Since the ordinary functions of components of the exposure apparatus are well known to one of ordinary skill in the related art, descriptions thereof will be omitted.

In addition, although a wafer is selected as an example of a substrate in the following description, the present invention is not limited thereto.

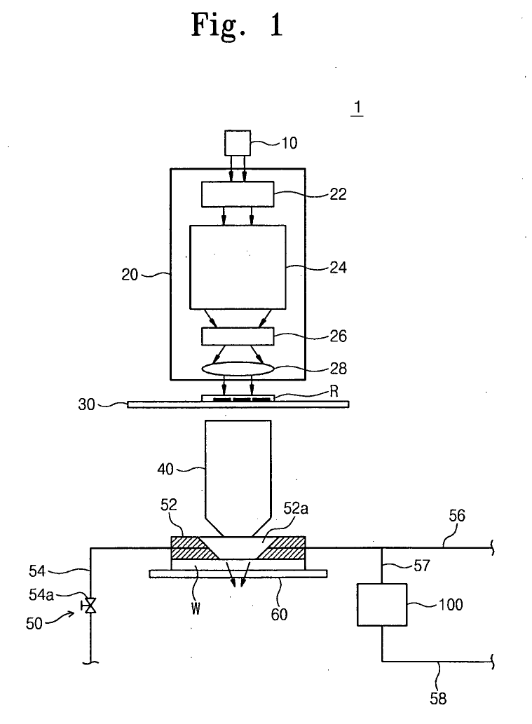

FIG. 1 is a schematic view illustrating an embodiment of an exposure apparatus according to aspects of the present invention.

A wafer (W) is placed on a wafer stage 60. A photoresist layer (not shown) is formed on the wafer (W), and a pattern is formed in the photoresist layer through exposure and development processes. The photoresist layer is formed on the wafer (W) through coating and soft baking processes. The patterned photoresist layer formed in this way can be used as an etch mask for etching an underlying layer or an ion implantation mask.

A plurality of shot regions is set for the wafer (W). Each shot region includes at least one die region. The size of the die region can be varied according to the type of a semiconductor device to be fabricated. The size of each shot region and the number of the shot regions can be determined by the size of the die region.

An exposure apparatus 1 includes a light source 10, an illumination optical system 20, a reticle stage 30, a projection optical system 40, an immersion exposure unit 50, and the wafer stage 60.

The light source 10 emits light for an exposing process. Examples of the light source 10 can include a mercury lamp, an ArF laser, a KrF laser, and an extreme ultraviolet beam or electron beam generator. The light source 10 is connected to the illumination optical system 20.

The illumination optical system 20 directs light emitted from the light source 10 to a reticle (R). Here, the illumination optical system 20 modifies the light emitted from the light source 10 (point light source) such that a predetermined area of the reticle can be exposed to the light.

The illumination optical system 20 includes a light intensity distribution control member 22, a light intensity control member 24, a blind member 26, and a condense lens 28.

The light intensity distribution control member 22 improves the uniformity of light emitted from the light source 10. The light intensity control member 24 controls a coherence factor σ. The blind member 26 blocks some portion of incident light to define an illumination area of the reticle (R). Therefore, only a desired area of the reticle (R) can be exposed by defining the illumination area of the reticle (R) using the blind member 26.

While passing through the illumination optical system 20, light emitted from the light source 10 is processed to conditions suitable for forming a photoresist pattern on the wafer (W). The suitable conditions of the light include the amount, intensity, and density of the light corresponding to the characteristics of a photoresist pattern to be formed on the wafer (W). It can be easy for those of ordinary skill in the related art to determine the suitable conditions of the light based on the aspect ratio of a photoresist pattern, the etch selectivity of photoresist, etc.

After passing through the illumination optical system 20, the light reaches the reticle (R) disposed-on the reticle stage 30. A plurality of circuit patterns are formed on the reticle (R) for the shot regions of the wafer (W). Then, the light passes through the reticle (R), and thus information about the circuit patterns can be contained in the light. The reticle (R) can be moved using the reticle stage 30.

After passing through the reticle (R), the light reaches the projection optical system 40. The projection optical system 40 directs the light containing the circuit pattern information to the wafer (W) to perform an exposure process. The projection optical system 40 has a cylindrical shape. An upper end of the projection optical system 40 faces the reticle (R), and a lower end of the projection optical system 40 faces the wafer (W).

An immersion exposure unit 50 is disposed at an optical path between the lower end of the projection optical system 40 and a top surface of the wafer (W). The immersion exposure unit 50 includes a vessel 52, a supply line 54, and a first drain line 56.

A fluid 52a is filled in the vessel 52. The fluid 52a contacts the lower end of the projection optical system 40 and the top surface of the wafer (W). The fluid 52a is used for immersion lithography. The fluid 52a can be a liquid having a refractive index greater than air (e.g., pure water or oil), or a predetermined gas. The fluid 52a improves resolution and depth of focus (DOF). In other words, the vessel 52 filled with the fluid 52a is functions as a liquid lens.

The fluid 52a is supplied to the vessel 52 through the supply line 54. A valve 54a is provided in the middle of the supply line 54 to open and close supply line 54. The fluid 52a drains from the vessel 52 through the first drain line 56.

The fluid 52a can be supplied to the vessel 52 in various manners. For example, a new fluid 52a can be supplied to the vessel 52 by continuously supplying the fluid 52a to the vessel 52 and draining the fluid 52a from the vessel 52 during an immersion exposure process. Alternatively, after a predetermined number of immersion exposure activities, the fluid 52a filled in the vessel 52 can be drained and then a new fluid 52a can be filled into the vessel 52.

An end of a collection line 57 is connected to the first drain line 56, and the other end of the collection line 57 is connected to a monitoring unit 100. The monitoring unit 100 monitors the state of the fluid 52a. For this, some of the fluid 52a draining through the first drain line 56 is guided to the monitoring unit 100 by the collection line 57. A second drain line 58 is connected to the monitoring unit 100 to receive the fluid 52a from the monitoring unit 100 after the fluid 52a is monitored. Embodiments of the monitoring unit 100 will now be described in more detail.

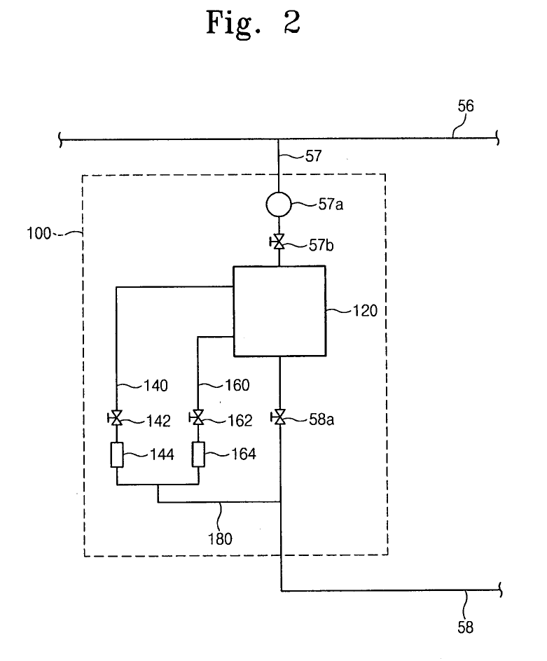

FIG. 2 is a schematic view illustrating a first embodiment of the monitoring unit 100 according to an aspect of the present invention.

The monitoring unit 100 includes a first bath 120, first distribution lines 140 and 160, and first measuring units 144 and 164. The first bath 120 stores a fluid 52a sampled through the collection line 57. A fluid meter 57a is installed in the collection line 57 to measure the amount of the sampled fluid 52a, and a valve 57b is installed in the collection line 57 to open and close the collection line 57.

The first distribution lines 140 and 160 are connected to the first bath 120. Although two distribution lines 140 and 160 are connected to the first bath 120 in the current embodiment, the present invention is not limited to this number of distribution lines. The first distribution lines 140 and 160 are used to supply the fluid 52a stored in the first bath 120 to the first measuring units 144 and 164. The number of the first distribution lines 140 and 160 can be determined by the number of the first measuring units 144 and 164.

Valves 142 and 162 are installed in the first distribution lines 140 and 160 to close and open the first distribution lines 140 and 160, respectively. The first measuring units 144 and 164 are installed in the first distribution lines 140 and 160 to measure one or more property of the fluid 52a supplied through the first distribution lines 140 and 160.

As explained above, properties of the fluid 52a filled in the vessel 52 largely affects the results of an immersion exposure process. Thus, the first measuring units 144 and 164 are used to measure at least one property of the fluid 52a, such as concentration, density, temperature, composition, and contamination level. The measured property of the fluid 52a is compared with an initial property of the fluid 52a to determine whether the property of the fluid 52a is changed.

In the current embodiment, the first measuring unit 144 is a high performance ion chromatography (HPIC) unit, and the first measuring unit 164 is an inductively coupled plasma-mass spectrometer (ICPMS). The HPIC unit and the ICPMS are well known to one of ordinary skill in the related art. Thus, descriptions thereof will be omitted. In the current embodiment, two measuring units 144 and 164 are used. However, it will be apparent to one of ordinary skill in the related art that the measuring unit 144 and 164 can be replaced with another measuring unit.

The second drain line 58 is connected to the first bath 120. The fluid 52a stored in the first bath 120 can be drained through the second drain line 58. The second drain line 58 can be connected to the first drain line 56. In this case, the fluid 52a stored in the first bath 120 can be drained through the second drain line 58 and the first drain line 56. A valve 58a can be installed in the second drain line 58 to close and open the second drain line 58.

As shown in FIG. 2, the first measuring units 144 and 164 are connected to the second drain line 58 through a first subsidiary drain line 180. Thus, a fluid 52a flows sequentially through the first distribution lines 140 and 160, the first measuring units 144 and 164, the first distribution lines 140 and 160, the first subsidiary drain line 180, and the second drain line 58.

Referring to FIG. 2, the monitoring unit 100 operates as follows. The valve 57b is opened, and a predetermined amount of fluid 52a is sampled to the first bath 120 by the fluid meter 57a installed in the collection line 57. The sampled fluid 52a stored in the first bath 120 is supplied to the first measuring units 144 and 164 through the first distribution lines 140 and 160. The first measuring units 144 and 164 measure at least one property of the fluid 52a, and then the fluid 52a is drained to the second drain line 58 through the first subsidiary drain line 180. If necessary, the fluid 52a stored in the first bath 120 can be drained directly through the second drain line 58.

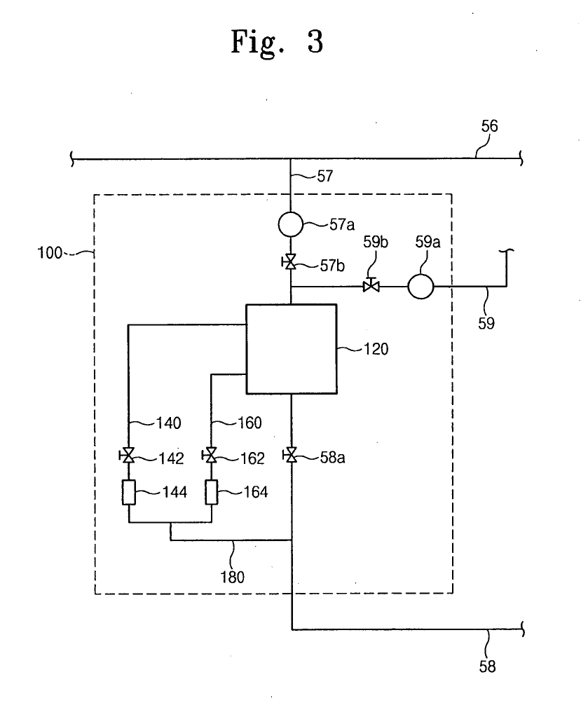

FIG. 3 is a schematic view illustrating a second embodiment of the monitoring unit 100 according to another aspect of the present invention.

Referring to FIG. 3, in the current embodiment, the monitoring unit 100 further includes a subsidiary supply line 59. The subsidiary supply line 59 can branch off from the supply line 54 shown in FIG. 1 to supply the first bath 120 with the same fluid 52a as that supplied to the vessel 52.

The subsidiary supply line 59 is connected to the collection line 57 to supply the fluid 52a. A fluid meter 59a is installed in the subsidiary supply line 59 to measure the flowrate of the fluid 52a, and a valve 59b is installed in the subsidiary supply line 59 to close and open the subsidiary supply line 59.

In the second embodiment shown in FIG. 3, the monitoring unit 100 operates as follows. The valve 57b is opened to sample a predetermined amount of fluid 52a and store the sampled fluid 52a to the first bath 120 using the fluid meter 57a installed in the collection line 57, and the valve 59b is opened to supply a predetermined amount of fluid 52a to the first bath 120 using the fluid meter 59a installed in the subsidiary supply line 59. The fluid 52a supplied to the first bath 120 through the subsidiary supply line 59 is the same as that supplied to the vessel 52. In other words, the fluid 52a supplied to the first bath 120 through the subsidiary supply line 59 is a fresh fluid that is not used for an immersion exposure process. In the first bath 120, the fluid 52a sampled through the collection line 57 is diluted to a predetermined ratio with the fluid 52a supplied through the subsidiary supply line 59.

The diluted fluid 52a is supplied to the first measuring units 144 and 164 through the first distribution lines 140 and 160. The first measuring units 144 and 164 measure the property of the fluid 52a, and then the fluid 52a is drained to the second drain line 58 through the first subsidiary drain line 180. If necessary, the fluid 52a stored in the first bath 120 can be drained directly through the second drain line 58.

The second embodiment shown in FIG. 3 is different from the first embodiment shown in FIG. 2 in that the sampled fluid 52a is diluted with the fresh fluid 52a not used for immersion exposure in the embodiment of FIG. 3. Although the amount of the fluid 52a sampled through the collection line 57 is small, the property of the sampled fluid 52a can be measured using the first measuring units 144 and 164 (e.g., an HPIC unit and ICPMS) as shown in FIG. 2. However, in the case where the first measuring units 144 and 164 are not capable of measuring the property of a small amount of fluid 52a, the sampled fluid 52a can be diluted with the fresh fluid 52a not used for immersion exposure. Accordingly, the amount of the fluid 52a is increased, and the property of a large amount of the diluted fluid 52a can be measured as shown in FIG.3.

In the current embodiment of FIG. 3, a relatively large amount of fluid 52a can be supplied to the first measuring units 144 and 164. Thus, measuring units, such as a total organic carbon (TOC) analyzer, a dissolve oxygen (DO) meter, a resistivity meter, and a particle counter, can be used as the first measuring units 144 and 164. Such measuring units are well known to one of ordinary skill in the related art, and thus descriptions thereof will be omitted. Although two measuring units 144 and 164 are used in the current embodiment, three measuring units can be used, for example, in other embodiments. Furthermore, measuring units other than the listed measuring units can be used as the first measuring units 144 and 164.

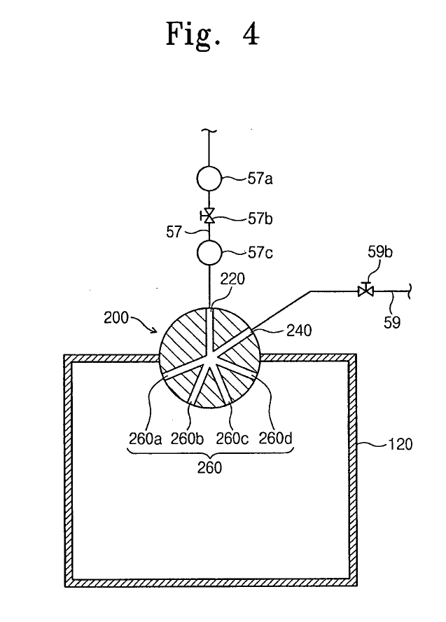

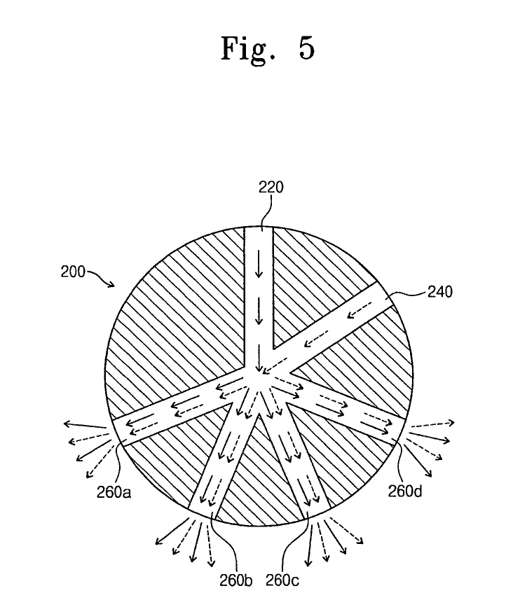

FIG. 4 is a view illustrating an embodiment of a mixer 200 to which the collection line 57 and the subsidiary supply line 59 are connected according to an aspect of the present invention, and FIG. 5 is a view illustrating fluid streams in the mixer 200.

In the monitoring unit 100 shown in FIG. 3, the fluid 52a sampled through the collection line 57 is mixed with the flesh fluid 52a supplied through the subsidiary supply line 59. However, the sampled fluid 52a and the fresh fluid 52a can be insufficiently mixed, and thus the insufficiently mixed fluid 52a can be supplied to the first measuring units 144 and 164. In this case, the first measuring units 144 and 164 can output false results. Therefore, it is necessary to sufficiently mix the sampled fluid 52a and the fresh fluid 52a. For this reason, the mixer 200 can be provided.

Referring to FIG. 4, the mixer 200 is coupled to an upper portion of the first bath 120. One side of the mixer 200 is exposed outside the first bath 120, and the other side of the mixer 200 is disposed inside the first bath 120. A first inlet 220 and a second inlet 240 are formed in the exposed side of the mixer 200, and first through fourth outlets 260a, 260b, 260c, and 260d are formed in the other side of the mixer 200. As shown in FIG. 4, in the mixer 200, the first and second inlets 220 and 240 are connected to the first through fourth outlets 260a, 260b, 260c, and 260d through interconnected paths. The interconnected paths have a radial shape extending from the center to the periphery of the mixer 200. The locations of the first and second inlets 220 and 240 can be interchangeable. Furthermore, the locations of the first through fourth outlets 260a, 260b, 260c, and 260d can be interchangeable.

The collection line 57 is connected to the first inlet 220, and the subsidiary supply line 59 is connected to the second inlet 240. Therefore, a fluid 52a sampled through the collection line 57 is introduced into the mixer 200 through the first inlet 220, a fresh fluid 52a supplied through the subsidiary supply line 59 is introduced into the mixer 200 through the second inlet 240.

Referring to FIG. 5, the sampled fluid 52a and the fresh fluid 52a are combined with each other in the center of the mixer 200. Thus, the sampled fluid 52a and the fresh fluid 52a can be sufficiently mixed with each other. Then, the mixed fluid 52a is guided to the first bath 120 through the first through fourth outlets 260a, 260b, 260c, and 260d and is stored in the first bath 120. In other words, the sampled fluid 52a and the fresh fluid 52a are first mixed in the mixer 200 and then are stored in the first bath 120 so that the fluid 52a sampled through the collection line 57 can be sufficiently mixed with the fresh fluid 52a supplied through the subsidiary supply line 59.

A blackflow preventer 57c is installed in the collection line 57. The blackflow preventer 57c is installed in the collection line 57 in front of the first inlet 220 to prevent a reverse flow of the fluid 52a from the first inlet 220 to the first drain line 56. When the pressure of the fresh fluid 52a supplied to the mixer 200 through the subsidiary supply line 59 is greater than the pressure of the sampled fluid 52a supplied to the mixer 200 through the collection line 57, the fluid 52a can flow reversely from the first inlet 220 to the first drain line 56. In this case, the immersion exposure process using the fluid 52a filled in the vessel 52 can be affected. Therefore, the backflow preventer 57c is used to prevent a backflow of the fluid 52a.

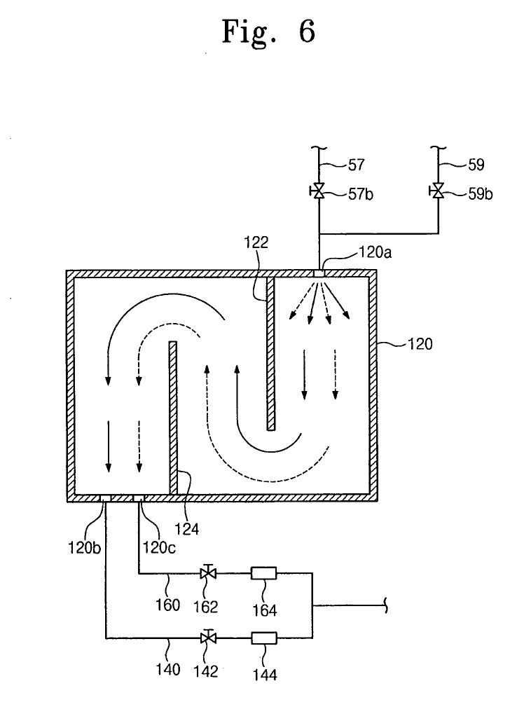

FIG. 6 is a schematic view illustrating an embodiment of the inside of the first bath 120 according to an aspect of the present invention.

An inlet hole 120a is formed in an upper side of the first bath 120, and first and second discharge holes 120b and 120c are formed in a lower side of the first bath 120. The collection line 57 is connected to the inlet hole 120a. Therefore, a fluid 52a sampled through the collection line 57 can be introduced into the first bath 120 through the inlet hole 120a. The first distribution lines 140 and 160 are connected to the first and second discharge holes 120b and 120c, respectively. A fluid 52a stored in the first bath 120 is discharged from the first bath 120 to the first distribution lines 140 and 160 through the first and second discharge holes 120b and 120c. The first distribution line 140 is connected to the first discharge hole 120b, and the first distribution line 160 is connected to the second discharge hole 120c.

First and second barrier walls 122 and 124 are formed in the first bath 120. The first barrier wall 122 extends downward from a ceiling of the first bath 120, and the second barrier wall 124 extends upward from a bottom of the first bath 120. The first and second barrier walls 122 and 124 divide the inside area of the first bath 120 into three interconnected compartments.

As shown in FIG. 6, a fluid 52a introduced into the first bath 120 through the inlet hole 120a flows down along the first barrier wall 122. Next, the fluid 52a passes through a gap between the first barrier wall 122 and the bottom of the first bath 120. Next, the fluid 52a flows upward between the first and second barrier walls 122 and 124. Next, the fluid 52a passes through a gap between the second barrier wall 124 and the ceiling of the first bath 120 towards the discharge holes 120b and 120c. Next, the fluid 52a flows down along the second barrier wall 124. Then, the fluid 52a is discharged to the first distribution lines 140 and 160 through the first and second discharge holes 120b and 120c.

In this way, the fluid 52a flows in zigzag in the first bath 120 owing to the first and second barrier walls 122 and 124. Therefore, a fluid 52a sampled through the collection line 57 and a fresh fluid 52a supplied through the subsidiary supply line 59 can be sufficiently mixed with each other.

The first and second barrier walls 122 and 124 are exemplary illustrated in FIG. 6. Other barrier walls can be used to dispose the inlet hole 120a and the first and second discharge holes 120b and 120c in different compartments in the first bath 120.

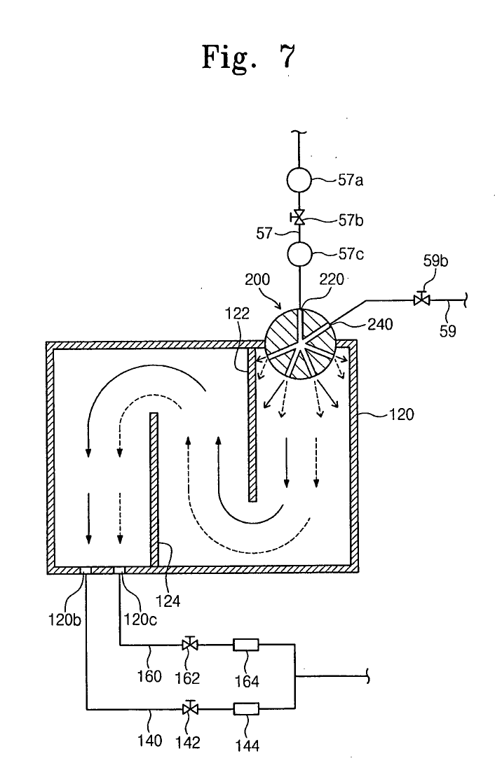

FIG. 7 is a view illustrating an embodiment of the mixer 200 of FIG. 5 installed in the first bath 120 of FIG. 6. Referring to FIG. 7, a sampled fluid 52a and a fresh fluid 52a can be first mixed using the mixer 200. Then, the sampled fluid 52a and the fresh fluid 52a can be mixed a second time using the first and second barrier walls 122 and 124. These first and second mixing operations are the same as those described in FIGS. 4 through 6. Thus, detailed descriptions thereof will be omitted.

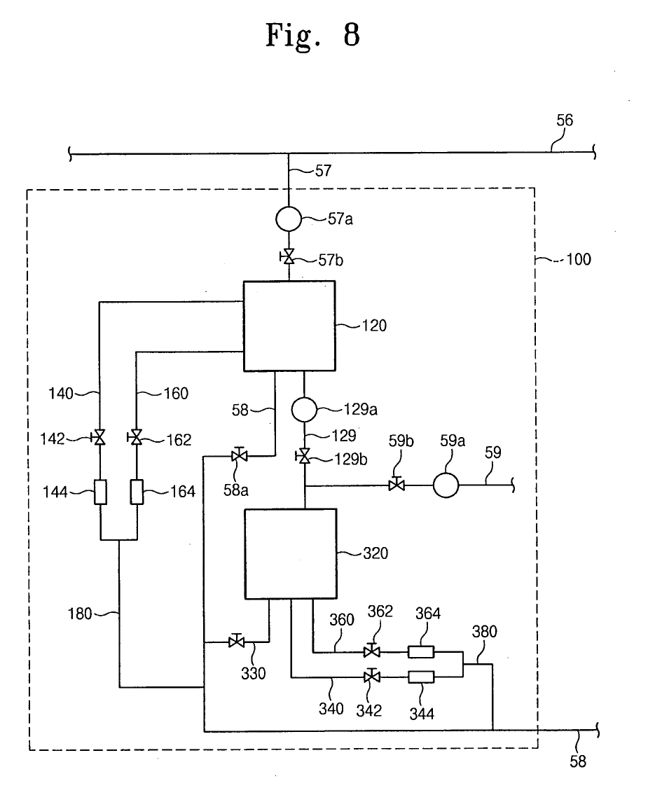

FIG. 8 is a schematic view illustrating a third embodiment of the monitoring unit 100 according to another aspect of the present invention.

The monitoring unit 100 of the current embodiment has the same basic elements as the monitoring unit 100 of FIG. 2. That is, like the monitoring unit 100 of FIG. 2, the monitoring unit 100 of the current embodiment is configured with a collection line 57, a first bath 120, first distribution lines 140 and 160, first measuring units 144 and 164, and a second drain line 58. In the following description, elements of the monitoring unit 100 of FIG. 8 different from those of the monitoring unit 100 of FIG. 2 will be described in detail. Other elements of the monitoring unit 100 of FIG. 8 are the same as those of the monitoring unit 100 of FIG. 2, so are not again described in detail.

A second bath 320 is disposed at a side of the first bath 120. The second bath 320 is connected to the first bath 120 through a communication line 129. A fluid 52a stored in the first bath 120 is discharged to the second bath 320 through the communication line 129. The second bath 320 stores the fluid 52a received from the first bath 120 through the communication line 129.

A fluid meter 129a is installed in the communication line 129 to measure the amount of the fluid 52a discharged from the first bath 120 to the second bath 320 through the communication line 129. A valve 129b is installed in the communication line 129 to close and open the communication line 129.

A subsidiary supply line 59 is connected to the communication line 129 to supply to the second bath 320 the same fluid 52a as that supplied to the vessel 52. For this, the subsidiary supply line 59 can branch off from the supply line 54 shown in FIG. 1. The subsidiary supply line 59 is connected to the communication line 129 to supply a fluid 52a to the second bath 320. A fluid meter 59a is installed in the subsidiary supply line 59 to measure the amount of the fluid 52a supplied through the subsidiary supply line 59, and a valve 59b is installed in the subsidiary supply line 59 to close and open the subsidiary supply line 59.

Second distribution lines 340 and 360 are connected to the second bath 320. In the current embodiment, the number of the second distribution lines 340 and 360 is two. However, the present invention is not limited to two second distribution lines, i.e., 340 and 360. Second measuring units 344 and 364 are installed in the second distribution lines 340 and 360, and the second distribution lines 340 and 360 are used to supply a fluid 52a stored in the second bath 320 to the second measuring units 344 and 364. The number of the second distribution lines 340 and 360 can be determined by the number of the second measuring units 344 and 364.

Valves 342 and 362 are respectively installed in the second distribution lines 340 and 360 to open and close the second distribution lines 340 and 360. The second measuring units 344 and 364 are installed in the second distribution lines 340 and 360 to measure the property of the fluid 52a supplied through the second distribution lines 340 and 360.

Like the first measuring units 144 and 164 shown in FIG. 3, the second measuring units 344 and 364 requires a relatively large amount of a fluid 52a to measure the property of the fluid 52a. That is, measuring units, such as a TOC analyzer, a DO meter, a resistivity meter, and a particle counter, can be used as the second measuring units 344 and 364. In the current embodiment, the number of the second measuring units 344 and 364 is two. However, it is apparent to one of ordinary skill in the related art that three or more measuring units can be used. In addition, measuring units other than the above-listed measuring units can be used.

Like the monitoring unit 100 shown in FIG. 2, the second drain line 58 is connected to the first bath 120. A fluid 52a stored in the first bath 120 can be drained through the second drain line 58. The second drain line 58 can be connected to the first drain line 56. In this case, the fluid 52a drained through the second drain line 58 can be finally drained through the first drain line 56. A valve 58a is installed in the second drain line 58 to open and close the second drain line 58.

As shown in FIG. 8, the first measuring units 144 and 164 are connected to the second drain line 58 through a first subsidiary drain line 180. A fluid 52a is introduced into the first measuring units 144 and 164 through the first distribution lines 140 and 160. Then, the fluid 52a is discharged from the first measuring units 144 and 164 through the first distribution lines 140 and 160. Thereafter, the fluid 52a is directed to the first subsidiary drain line 180 from the first distribution lines 140 and 160. Then, the fluid 52a is drained through the second drain line 58.

A third drain line 330 is connected to the second bath 320. A fluid 52a stored in the second bath 320 can be drained through the third drain line 330. The third drain line 330 is connected to the second drain line 58. Thus, the fluid 52a stored in the second bath 320 can be drained through the third drain line 330 and the second drain line 58. However, the third drain line 330 and the second drain line 58 can be separately provided for draining the fluid 52a individually. A valve 330a is installed in the third drain line 330 to open and close the third drain line 330.

As shown in FIG. 8, the second measuring units 344 and 364 are connected to the second drain line 58 through a second subsidiary drain line 380. A fluid 52a is introduced into the second measuring units 344 and 364 through the second distribution lines 340 and 360. Then, the fluid 52a is discharged from the second measuring units 344 and 364 to the second subsidiary drain line 380 through the second distribution lines 340 and 360. Thereafter, the fluid 52a is drained through the second drain line 58.

The monitoring unit 100 of FIG. 8 operates as follows. The valve 57b is opened, and a predetermined amount of fluid 52a is sampled to the first bath 120 by the fluid meter 57a installed in the collection line 57. The sampled fluid 52a is first stored in the first bath 120 and is supplied to the first measuring units 144 and 164 through the first distribution lines 140 and 160. The first measuring units 144 and 164 measure the property of the fluid 52a, and then the fluid 52a is drained to the second drain line 58 through the first subsidiary drain line 180. If necessary, the fluid 52a stored in the first bath 120 can be drained directly through the second drain line 58.

Furthermore, the valve 129b is opened to supply a predetermined amount of the sampled fluid 52a from the first bath 120 to the second bath 320 using the fluid meter 129a installed in the communication line 129, and the valve 59b is opened to supply a predetermined amount of fluid 52a to the second bath 320 using the fluid meter 59a installed in the subsidiary supply line 59. The fluid 52a supplied to the second bath 320 through the subsidiary supply line 59 is the same as that supplied to the vessel 52. In other words, the fluid 52a supplied to the second bath 320 through the subsidiary supply line 59 is a fresh fluid that is not used for an immersion exposure process. Therefore, in the second bath 320, the sampled fluid 52a is diluted in a predetermined ratio with the fresh fluid 52a supplied through the subsidiary supply line 59.

The diluted fluid 52a is supplied from the second bath 320 to the second measuring units 344 and 364 through the second distribution lines 340 and 360. The second measuring units 344 and 364 measure at least one property of the fluid 52a, and then the fluid 52a is drained to the second drain line 58 through the second subsidiary drain line 380. If necessary, the fluid 52a stored in the second bath 320 can be drained directly through the third drain line 330.

Although not shown in FIG. 8, the mixer 200 shown in FIGS. 4 and 5 can be installed in the second bath 320, and the first and second barrier walls 122 and 124 can be installed in the second bath 320 to further mix the sampled fluid 52a supplied to the second bath 320 through the communication line 129 with the fresh fluid 52a supplied to the second bath 320 through the subsidiary supply line 59. In view of the description provided herein one of ordinary skill in the related art could apply the mixer 200 and/or the first and second barrier walls 122 and 124, discussed with respect to the other monitoring unit embodiments, to the monitoring unit 100 shown in FIG. 8. Thus, detailed description thereof will be omitted.

As explained above, at least one property of the fluid 52a filled in the vessel 52 can be precisely detected. Furthermore, the amount of the fluid 52a supplied to the measuring units can be adjusted according to the characteristics of the measuring units, and thus various measuring units can be used to measure the property of the fluid 52a. Therefore, process errors and wafers having defective patterns can be prevented.

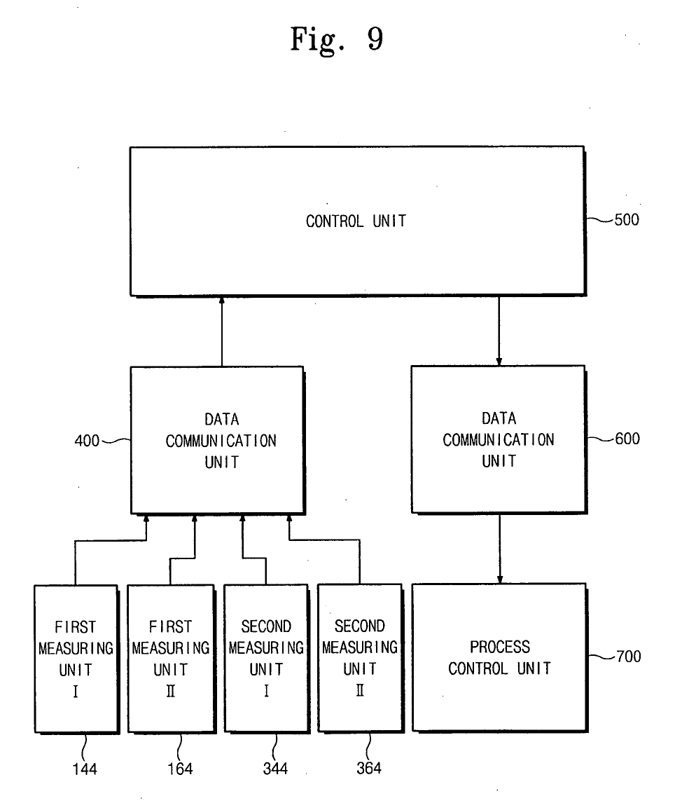

FIG. 9 is a block diagram for explaining an embodiment of a method of exposing a substrate according to aspects of the present invention.

As explained above, the first measuring units 144 and 164 and the second measuring units 344 and 364 are used to measure at least one property of a sampled fluid 52a, and the measured property of the sampled fluid 52a is transmitted to a control unit 500 through a data communication unit 400.

The control unit 500 includes a storage device (not shown). The storage device stores the initial property of the fluid 52a that is supplied to the vessel 52. That is, the storage device stores the property of the fluid 52a before the fluid 52a is used for an immersion exposure process.

The control unit 500 compares the received property of the sampled fluid 52a with the initial property of the fluid 52a to determine whether the property of the sampled fluid 52a is different from the initial property of the fluid 52a within a predetermined range. If so, an immersion exposure process is continued. If not, the control unit 500 sends a process stop signal to a process control unit 700 through a data communication unit 600. Then, the process control unit 700 suspends the immersion exposure process.

As described above, according to aspects of the present invention, at least one property of a fluid used for an immersion exposure process can be easily detected. Furthermore, a small amount of the fluid or a relatively large amount of the fluid can be selectively supplied to the measuring unit depending on the characteristics of the measuring unit, so that various measuring devices can be used for the measuring unit to detect the property of the fluid. In addition, when the property of the fluid varies from the initial property of the fluid by more than a predetermined degree, the immersion exposure process can be suspended to prevent defectives.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus for exposing a substrate, comprising:
a light source configured to emit light;
an illumination optical system configured to illuminate a reticle loaded on a reticle stage with the light emitted from the light source;
a projection optical system configured to irradiate the light transmitted through the reticle onto a substrate loaded on a substrate stage; and
an immersion exposure unit configured to supply a liquid to an optical path between the projection optical system and the substrate,
wherein the immersion exposure unit comprises:
a vessel disposed on the optical path and filled with the liquid;
a supply line connected to one side of the vessel and configured to supply the liquid to the vessel;
a first drain line connected to the other side of the vessel and configured to drain the liquid from the vessel; and
a monitoring unit connected to the first drain line and comprising at least one first measuring unit configured to detect a property of the liquid flowing through the first drain line.

2. The apparatus of claim 1, wherein the monitoring unit further comprises:
a collection line connected to the first drain line and configured to collect the liquid;
a first bath configured to store the liquid collected through the collection line; and
a first distribution line connected to the first bath configured to allow the liquid in the first bath to flow therethrough,
wherein the first measuring unit is installed on the first distribution line.

3. The apparatus of claim 2, wherein the monitoring unit further comprises a second drain line connected to the first bath and configured to drain the liquid from the first bath.

4. The apparatus of claim 3, wherein the monitoring unit further comprises a first subsidiary drain line connecting the first measuring unit and the second drain line.

5. The apparatus of claim 2, wherein the first measuring unit is one of a high performance ion chromatography (HPIC) unit and an inductively coupled plasma-mass spectrometer (ICPMS).

6. The apparatus of claim 2, wherein the monitoring unit further comprises a subsidiary supply line configured to supply the first bath with the same liquid as that supplied to the vessel.

7. The apparatus of claim 6, wherein the monitoring unit further comprises a fluid meter installed on the subsidiary supply line.

8. The apparatus of claim 6, wherein the monitoring unit further comprises a mixer including a first inlet connected to an end of the collection line to receive the collected liquid, and a second inlet connected to an end of the subsidiary supply line to receive the same liquid as that supplied to the vessel.

9. The apparatus of claim 8, wherein the mixer further includes a plurality of outlets configured to discharge the liquids introduced through the first and second inlets.

10. The apparatus of claim 8, wherein the monitoring unit further comprises a backflow preventer provided on the collection line and configured to prevent the liquids introduced into the mixer through the first and second inlets from reversely flowing along the collection line.

11. The apparatus of claim 6, wherein the first bath comprises one or more barrier walls configured to divide an inside area of the first bath into a plurality of interconnected compartments.

12. The apparatus of claim 11, wherein the barrier walls comprise:
a first vertical barrier wall extending downward from a ceiling surface of the first bath; and
a second vertical barrier wall extending upward from a bottom surface of the first bath.

13. The apparatus of claim 6, wherein the first measuring unit is one of a total organic carbon (TOC) analyzer, a dissolve oxygen (DO) meter, a resistivity meter, and a particle counter.

14. The apparatus of claim 2, wherein the monitoring unit further comprises:
a communication line connected to the first bath to allow the liquid in the first bath to flow therethrough;
a second bath connected to the communication line to receive the liquid through the communication line;
at least one second distribution line connected to the second bath and configured to allow the liquid in the second bath to flow therethrough; and
at least one second measuring unit installed on the second distribution line and configured to measure a property of the liquid flowing through the second distribution line.

15. The apparatus of claim 14, wherein the monitoring unit further comprises a subsidiary supply line configured to supply the second bath with the same liquid as that supplied to the vessel.

16. The apparatus of claim 15, wherein the monitoring unit further comprises a mixer including a first inlet connected to an end of the collection line and configured to receive the collected liquid, and a second inlet connected to an end of the subsidiary supply line and configured to receive the same liquid as that supplied to the vessel.

17. The apparatus of claim 16, wherein the monitoring unit further comprises a backflow preventer provided on the collection line and configured to prevent the liquids introduced into the mixer through the first and second inlets from reversely flowing along the collection line.

18. The apparatus of claim 15, wherein the second bath comprises one or more barrier walls dividing an inside area of the second bath into a plurality of interconnected compartments.

19. The apparatus of claim 14, wherein the monitoring unit further comprises:
a second drain line connected to the first bath and configured to drain the liquid from the first bath; and
a third drain line connected to the second bath and the second drain line and configured to discharge the liquid from the second bath to the second drain line.

20. The apparatus of claim 19, wherein the monitoring unit further comprises:
a first subsidiary drain line configured to connect the first measuring unit and the second drain line; and
a second subsidiary drain line configured to connect the second measuring unit and the second drain line.

21. An apparatus for exposing a substrate, comprising:
a light source configured to emit light;
an illumination optical system configured to illuminate a reticle loaded on a reticle stage with the light emitted from the light source;
a projection optical system configured to irradiate the light transmitted through the reticle onto a substrate loaded on a substrate stage;
a liquid lens filled with a liquid and disposed on an optical path between the projection optical system and the substrate; and
a monitoring unit configured to sample the liquid from liquid lens to measure a property of the liquid.

22. The apparatus of claim 21, wherein the monitoring unit comprises:
a first bath configured to store the sampled liquid;
at least one first distribution line connected to the first bath to allow the liquid in the first bath to flow therethrough; and
at least one first measuring unit installed on the first distribution line and configured to measure a property of the liquid flowing through the first distribution line.

23. The apparatus of claim 22, wherein the first measuring unit is one of a high performance ion chromatography (HPIC) unit and an inductively coupled plasma-mass spectrometer (ICPMS).

24. The apparatus of claim 22, wherein the monitoring unit further comprises a subsidiary supply line configured to supply the first bath with the same liquid as that supplied to the liquid lens.

25. The apparatus of claim 22, wherein the monitoring unit further comprises:
a communication line connected to the first bath and configured to allow the liquid in the first bath to flow therethrough;
a second bath connected to the communication line and configured to receive the liquid through the communication line;
at least one second distribution line connected to the second bath and configured to allow the liquid in the second bath to flow therethrough; and
at least one second measuring unit installed on the second distribution line and configured to measure a property of the liquid flowing through the second distribution line.

26. The apparatus of claim 25, wherein the monitoring unit further comprises a subsidiary supply line configured to supply the second bath with the same liquid as that supplied to the liquid lens.

27. A method of exposing a substrate to light transmitted through a liquid, the liquid being supplied to an optical path between the substrate and an projection optical system irradiating light transmitted through a reticle to the substrate,
the method comprising sampling the liquid supplied to the optical path and measuring a property of the sampled liquid using a first measuring unit.

28. The method of claim 27, further comprising:
storing an initial property of the liquid measured before supplying the liquid to the optical path;
comparing the stored initial property of the liquid with the property of the liquid measured using the first measuring unit; and
if the property of the liquid measured using the first measuring unit is different from the initial property of the liquid by more than a predetermined amount, stopping an exposure process.

29. The method of claim 27, further comprising:
diluting the sampled liquid by mixing some of the sampled liquid with the liquid that is not supplied to the optical path; and
measuring a property of the diluted liquid using a second measuring unit.

30. The method of claim 29, further comprising:
storing initial properties of the liquid measured before the liquid is supplied to the optical path;
comparing the stored initial properties of the liquid with the properties of the liquid measured using the first and second measuring units, respectively; and
if one of the properties of the liquid measured using the first and second measuring units is different from the initial property of the liquid by more than a predetermined amount, stopping an exposure process.
